(19) United States
(12) Patent Application Publication
(10) Pub. No.: US 2011/0199181 A1
(43) Pub. Date: Aug. 18, 2011

(54) CODED REMOTE CONTROLLER AND MEANS TO SECURE ENTRY

(76) Inventor: Luis M. Ortiz, Albuquerque, NM (US)

(21) Appl. No.: 13/030,037

(22) Filed: Feb. 17, 2011

Related U.S. Application Data
(60) Provisional application No. 61/305,190, filed on Feb. 17, 2010.

(51) Int. Cl. G06F 7/04

(52) U.S. Cl. 340/5.7

(57) ABSTRACT

Systems and methods to ensure security over remote controlled entries using a remote control transmitter that only transmits a command to open a secured entry (e.g. gate or garage door) if a unique pattern (e.g., number pattern or biometric) is entered into a wireless remote control and transmitter. The remote control transmitter can include three or more buttons or a biometric input whereon a unique pattern is entered in order to cause the transmitter to send an RF signal to a matching/paired receiver associated with the secured entry. If the proper code is not entered onto the keypad or buttons associated with the remote control transmitter within a preselected number of tries (for example, three), then the remote control/transmitter can become inoperable for a period of time before entry can be attempted again.

### CROSS-REFERENCE TO PROVISIONAL APPLICATION

This nonprovisional patent application claims the benefit under 35 U.S.C. §119(e) of U.S. Provisional Patent Application Ser. No. 61/305,190 filed on Feb. 17, 2010, entitled “CODED REMOTE CONTROLLER AND MEANS TO SECURE ENTRY,” which is hereby incorporated by reference in its entirety.

### BACKGROUND OF THE INVENTION

Remote control garage door or entry door openers have been around for some time and remain straight-forward in operation and architecture. A portable RF transmitter is coded to open, or is matched with an opener associated with, a secure entry (e.g., garage doors and gates). The RF transmitter is typically handheld, wireless and sends a RF signal that is matched with or learned by the entry receiver. For example, a transmitter in the form of a portable garage door opener, typically kept in an automobile, is matched by a unique RF signal generated by the transmitter to a receiver associated with the garage door opener equipment. A single button can be pressed on the transmitter to open or close a garage door or gate by transmission of a coded signal and/or unique frequency.

The problem with door openers is that they can be stolen from an automobile and used to gain entry into a secure environment, such as a private residence. This is so because automobiles that are left parked outside a residence, or are parked at a store or public area, will typically have a portable transmitter attached to the sun visor or located somewhere in the automobile. A thief can smash the window of the automobile, or even gain access to the interior compartment of a vehicle if it's unlocked, and take the opener together with home address information typically stored in a glove box to use to gain entry into the secure environments. So, even if the vehicle is not located outside of the secured environment (the owners residence), a thief can also find out where the owner of the vehicle lives by taking registration papers typically stored in the automobile's glove box or other storage areas. This is because a personal vehicle is often left for many hours in public places (office building, shopping center, airport parking lot, golf course) where a thief can access both and remote entry device and residential location information. What is needed, therefore, are more secure methods and systems for enabling access to a secured environment and preventing unauthorized entry to the same.

### SUMMARY

The present invention includes a system to ensure security over remote controlled entries using a remote control transmitter that only transmits a command to open a secured entry (e.g. gate or garage door) if a unique number pattern or code is entered into the remote control transmitter. The remote control transmitter can include three or more buttons whereon a unique pattern is entered in order to cause the transmitter to send an RF signal to a matching/paired receiver associated with the secured entry. If the proper code is not entered onto the keypad or buttons associated with the remote control transmitter within a preselected number of tries (for example, three), then the remote control/transmitter can become inoperable for a period of time (e.g., five or more minutes) before entry can be attempted again. If unsuccessful entry is attempted on more than another preselected number of tries (e.g., three times or more), then the remote control transmitter can become inoperable for a much longer duration of time, or permanently.

The remote control transmitter can be adapted to operate with any currently existing receivers, such as standard garage door openers. The remote control transmitter can be matched with the garage door opener through procedures known in the art such as programming the entry receiver to recognize a unique code transmitted from the transmitter. After matching the transmitter with the receiver, however, the unique code on the transmitter will only be transmitted from the transmitter if the proper combination of key entries is entered on the transmitter.

As an alternate embodiment, the remote control transmitter can be coded with a biometric template as the unique code, the biometric template memorized from at least one user authorized with entry into the secured embodiment. Other than a unique pattern of numbers or key entries, a biometric (e.g., fingerprint) can be used as the unique code to activate transmission of the RF signal from the remote control to the secured entry receiver.

Accordingly, what is provided is a portable, wireless transmitter for enabling access to secured entries. A memory can be adapted to store unique signals used for transmission by a wireless transmitter and for storing unique entry patterns (keypad entries or biometrics template) provided by a user interface. A controller having access to the memory and adapted to provide at least one unique signal to a wireless transmitter and unique entry patterns as input signals from at least one of a biometric sensor or at least three button switches can also be provided. A wireless transmitter can be provided that can be adapted to transmit at least one unique radio frequency provided from said controller.

In accordance with another feature of the present invention, a user interface can be included with at least one of a biometric sensor or at least three button switches in communication with said controller.

During use, a user will enter a unique pattern of numbers (or a biometric if a biometric reader is used), which will then activate the transmitter to send an RF signal to the entry circuit receiver.

During programming, the user can enter a unique pattern (e.g., any combination of 0-9, or a biometric) for storage in the memory. Re-entry of the pattern can initiate transmission of the RF signals.

After programming, the remote controller's unique signal can be matched with (programmed to operate) the entry system hardware, by methods known in the art of garage door and entry openers.

It can be appreciated that the remote controller may be used to open more than one secure entry. Several unique transmission signals can be transmitted by the remote controller. Each unique transmission signal can be associated with a different unique pattern (e.g., a unique combination of numbers from 0-9, or a different biometric sample such as a thumb or index finger).

### DRAWINGS

FIG. 1, labeled as prior art, illustrates modules of a typical entry system;

FIG. 2A illustrates a remote controller and user interface in accordance with a feature of the present invention;

FIG. 2B illustrates a remote controller and user interface in accordance with another feature of the present invention; and

FIG. 3 illustrates modules of an electronic system for a remote controller in accordance with another feature of the present invention.

### DETAILED DESCRIPTION

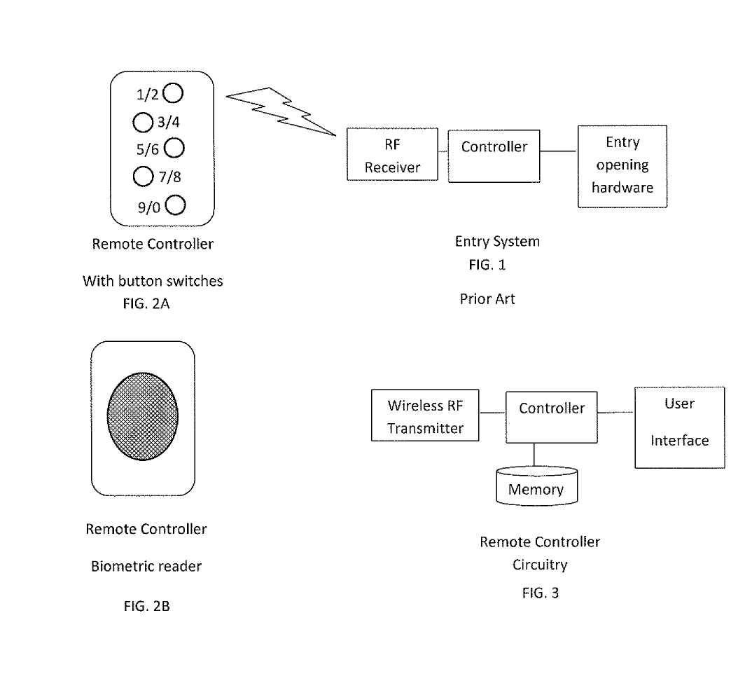

Referring to FIG. 1, what is labeled as prior art is a secured entry system typically used with a garage door, gated entry, or other secured entries requiring remote activation. A remote entry will normally include an RF receiver, a controller and entry opening hardware (which is typically eletromechanical).

Referring to FIG. 2A, a remote controller is illustrated with push-buttons label 1/2, 3/4, 5/6, 7/8, 9/0, in accordance with features of the invention. A user can enter a number code as the unique pattern that can include, for example, at least three numbers in order to cause the code for entry to be transmitted from the remote controller. For example the opening code in RF form can be transmitted is a user types in a preprogrammed (preset at initiation) code of “1350” by pushing the 1/2 button, followed by the 3/4 button, followed by the 5/6 button, and then followed by the 9/0 button, which would complete the matching four digit code stored in memory.

Referring to FIG. 2B, a remote controller is illustrated with a biometric input for fingerprints, in accordance with a feature of the present invention. A user can rub their fingerprint across the biometric sensor. If the biometric matches a stored biometric in the remote control, a code will be transmitted to the secured entry enabling user access through the secured entry. If no match, then the code will not be sent.

Referring to FIG. 3, a block diagram of modules for the remote control of the present invention are illustrated. The remote control includes a controller, a memory, a user interface and a radio frequency transmitter.

1. A portable, wireless transmitter for enabling access to secured entries, comprising:
a controller;
a user interface including at least one of a biometric sensor or at least three button switches in communication with said controller;
a memory accessible by said controller and storing unique signals used for transmission by a wireless transmitter and for storing unique entry patterns provided by a user interface;
a controller having access to said memory and adapted to provide at least one unique signal to a wireless transmitter and unique entry patterns as input signals from at least one of a biometric sensor or at least three button switches;
a wireless RF transmitter adapted to transmit at least one unique radio frequency provided from said controller.

2. The method of claim 2 wherein said user interface includes a biometric sensor and said unique pattern is a user fingerprint.

3. The method of claim 2 wherein said user interface includes at least three button switches and said unique pattern is a number pattern entered on said at least three button switches by a user.

4. A portable, wireless transmitter for enabling access to secured entries, comprising:
a controller;
a user interface in communication with a controller and including at least one of a biometric sensor or at least three button switches;
a memory accessible by said controller and adapted to store unique signals used for transmission by a wireless transmitter and for storing unique entry patterns provided on said user interface; and
a wireless RF transmitter in communication with said controller, wherein said controller matches a unique entry pattern provided as input signals from at least one of a biometric sensor or at least three button switches with unique entry patterns stored in said memory and providing at least one unique signal obtained from memory to a wireless RF transmitter for transmission to a secure entry receiver if unique entry patterns entered on said user interface match stored unique entry patterns.

5. A method using a portable, wireless transmitter for authorized access to secured entries, comprising:
providing a portable, wireless remote control including a controller, a user interface in communication with a controller, a wireless transmitter in communication with said controller and a memory accessible by said controller and adapted to store unique signals used for transmission by said wireless transmitter and for storing unique entry patterns provided by a user on said user interface;
initiating said portable, wireless remote control in association with a unique signal associated with a secured entry by accepting an initial unique entry pattern from a user on said user interface and storing the initial unique pattern in memory; and
using said portable, wireless remote control after initiation to gain access to a secure entry wherein said controller matches a operational unique entry pattern with the initial unique entry pattern stored in said memory and providing at least one unique signal obtained from memory to a wireless RF transmitter for transmission to a secure entry receiver if unique entry patterns match.

6. The method of claim 2 wherein said user interface includes a biometric sensor and said unique pattern is a user fingerprint.

7. The method of claim 2 wherein said user interface includes at least three button switches and said unique pattern is a number pattern entered on said at least three button switches by a user.
